(19) United States
(12) Patent Application Publication
(10) Pub. No.: US 2014/0305518 A1
(43) Pub. Date: Oct. 16, 2014

(54) Oilfield Safety Valve

(71) Applicant: Jason Stotler, Bakersfield, CA (US)

(72) Inventor: Jason Stotler, Bakersfield, CA (US)

(21) Appl. No.: 13/860,020

(22) Filed: Apr. 10, 2013

(51) Int. Cl. E21B 34/06; F16K 5/06

(52) U.S. Cl. CPC E21B 34/06; F16K 5/06
USPC 137/315.18

(57) ABSTRACT

An improved safety valve for oilfield operations comprising a first valve body comprising: an axial bore adapted to allow fluids to pass, a first end operatively engaging pump equipment, and a second end adapted to axially compress with a second valve body; the second valve body comprising an axial bore, adapted to axially compress with a second end of an intermediate valve body connector and the second end of the first valve body, and a second end operatively engaging pump equipment; the intermediate valve body connector having an axial bore and means for axial compression with the second valve body; the axial bores of the first and second valve bodies and the intermediate connector adapted to being axially aligned when compressed; and a valve internally disposed between the first valve body and the intermediate valve body connector and the second valve body and actuated by an externally accessible torque means.

### FIELD OF THE INVENTION

The present invention relates to safety valves for oil drilling operations. More specifically, the present invention relates to an improved valve assembly for preventing valve failure from over tightening and easy replacement and reuse of failed safety valves.

### BACKGROUND

In oil drilling operations, generally, there are above-hole operations and down-hole operations. Above-hole, there is the pumping unit and its related piping, valves, and other oil production systems. Down-hole operations are made up of down-hole tubing and plungers that are connected to a “string” reciprocally actuated by the pumping unit. During pumping operations, the primary well tubing is often sealed through a well tee and/or box and which directs pumped oil out through above-ground production tubing for later processing and refinement. During a workover of the pumping unit the tee or box will need to be removed and a safety valve will need to be secured to the oil tubing to prevent blowouts. Other times, a safety valve will be placed on the tubing for other purposes. The sucker rod string can extend for hundreds or thousands of feet and which leaves the tubing exposed and susceptible to blowout or uncontrolled oil expulsion. Safety valves are used to prevent blowout or to cap the exposed drill pipe or tubing from fluids that are forced to the surface through latent well pressure. Safety valves are designed to “stab” into the drill pipe or tubing at the rig floor and close quickly in case a well kicks in. Safety valves commonly use internal ball valves to stop flow through the drill string that begin when the drill string is being withdrawn from the well.

Traditionally, safety valves are formed from upper and lower tubular sections with an internal ball valve. Seats or seals, internal to the upper and lower tubular sections, allow a ball of a ball valve to “float” between the two valve bodies. The ball valve is either open or closed by an externally accessible valve stem, crank, or set screw. This type of valve has been around for some time and is also known as a “TIW” valve which is the abbreviated name of their original manufacturer. (“Texas Iron Works”)

Valve failures can occur for a variety of reasons. One of these is over-tightening of the valves. This is explained by a study done in 2002 by Louisiana State University, Study of Drill String Safety Valves, and which is referenced herein. That study explained that, “Wear on the valve stem stop can sometimes allow too much rotation of the ball. Deformation of the valve stem stop can be caused by applying excessive torque when using a cheater bar. Design constraints resulting from maximum outside diameter, minimum inside diameter, and a high working pressure requirements make it difficult to design robust valve stops.” (See, FIG. 9, page 11) Over-tightening eventually leads to blowouts. Further, it also deforms the seats on the lower valve body and which means the entire valve needs to be replaced. Current changes to valve failures as described therein and in recent valve patents and applications have been limited to designs in the internal ball valves rather than the problems that occur from over-tightening the upper and lower portions of safety valves.

Another problem associated with over-tightening is expense in that an entire new valve must be used or taken from a replacement section from another valve. When one or more work overs are needed, this increases cost. Further, safety valves are required by law to be readily available next to each well. If one is not available, then operations must cease until one becomes available or safety is compromised and operators are penalized.

What is needed is an improved valve assembly with a replaceable connector to increase valve integrity and reduce valve failure costs from over-tightening.

### BRIEF DESCRIPTION OF THE DRAWINGS

FIG. 1 A cross-sectional view of a safety valve with an intermediate connector.

FIG. 2 An exploded view of a safety valve with an intermediate connector.

FIG. 3 A side view of a safety valve with an externally accessible torque means for opening and closing a valve.

FIG. 4 A side view of a safety valve.

FIG. 5 A bottom view of an intermediate safety valve body connector.

FIG. 6 A side view of an intermediate safety valve body connector.

FIG. 7 A top view of an intermediate safety valve body connector.

FIG. 8 An upper valve body adjacent to and intermediate safety valve body connector.

### DETAILED DESCRIPTION OF THE DRAWINGS

In standard safety valve used commonly in oilfield operations, a valve is disassembled whereby the upper valve body is unthreaded from the lower valve body. Generally, a ball valve or other operable valve assembly is caged between the upper and lower valve bodies. A turning or torque mechanism for actuating the internal valve is externally accessible through an aperture aligned with a spring mounted guide or other torque assembly for using torque to open or close the valve. Those skilled in the art will appreciate that there are various known methods for applying torque to turn a valve, such as a ball valve, including set screws, levers, or slotted receiver. The lower valve body will usually have a male threaded end which mates with an internal female threaded end of the upper valve body. In the field, these are most often manually tightened so as to axially compress the two valve bodies to create a secure seal. Without a secure seal, this compromises the valve's integrity and latent well pressure will force its way through broken or compromised valves or seals. This can often happen because of over tightening of the upper and lower body of safety valves. For example, a common occurrence is that over tightening will compromise the shoulder of the upper portion of the lower valve. Because there are statutory and other requirements for having operable safety valves in the proximity of well operations, if one should be compromised, and if there are no operable safety valves, oilfield operators are both out of compliance and the safety of the workers are compromised.

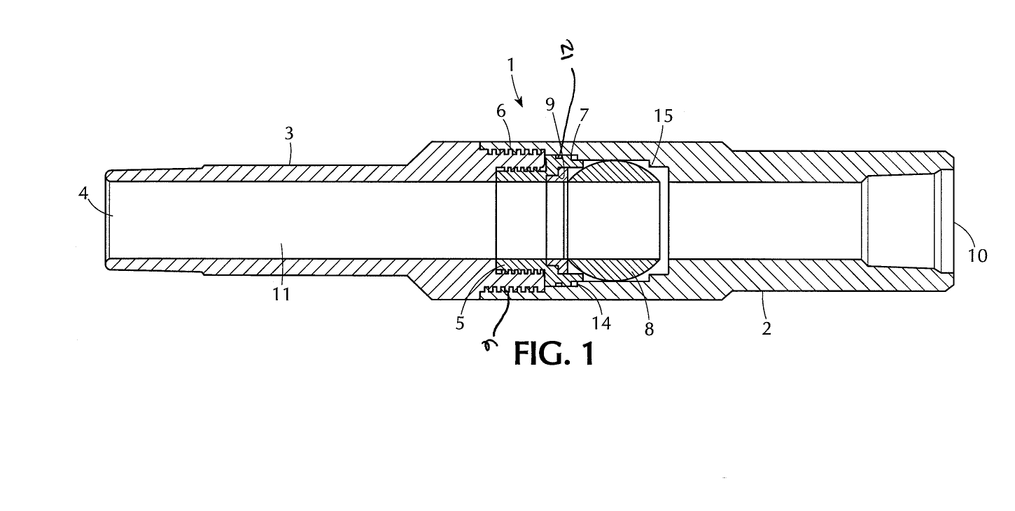

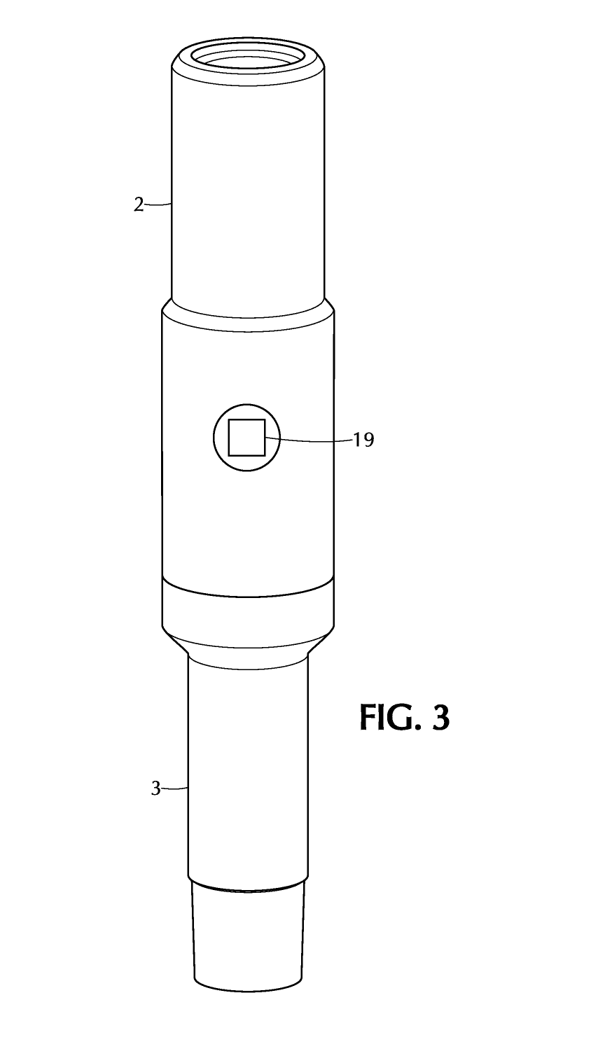

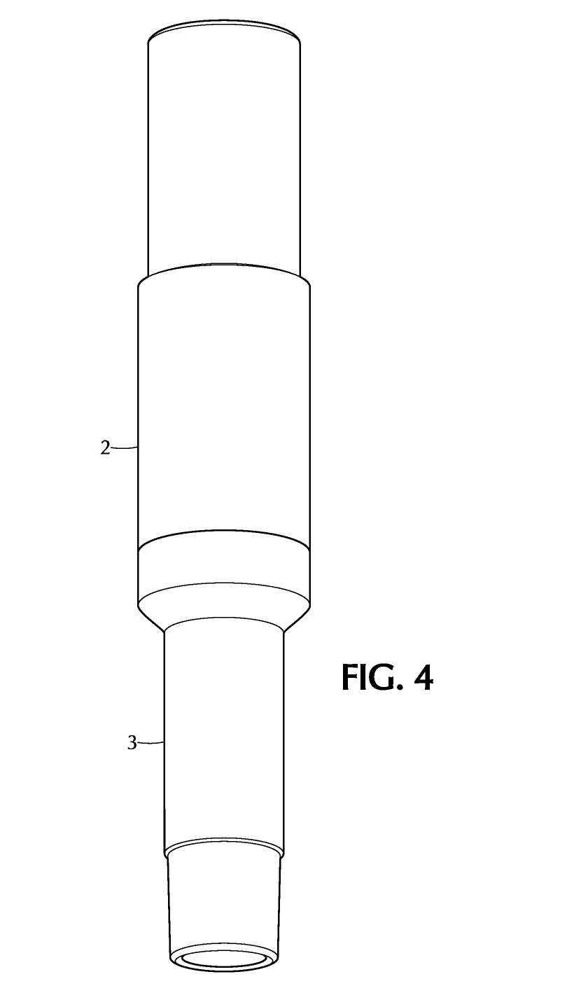

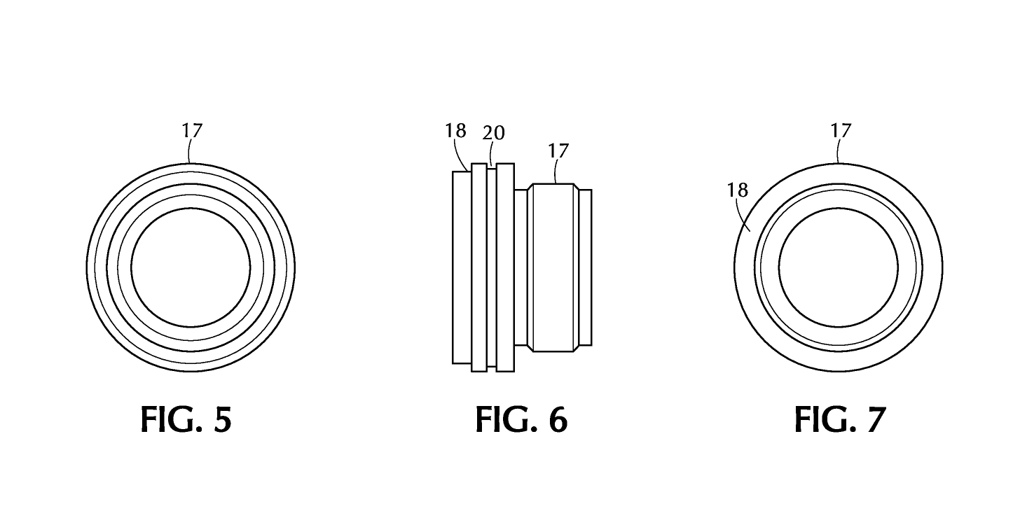

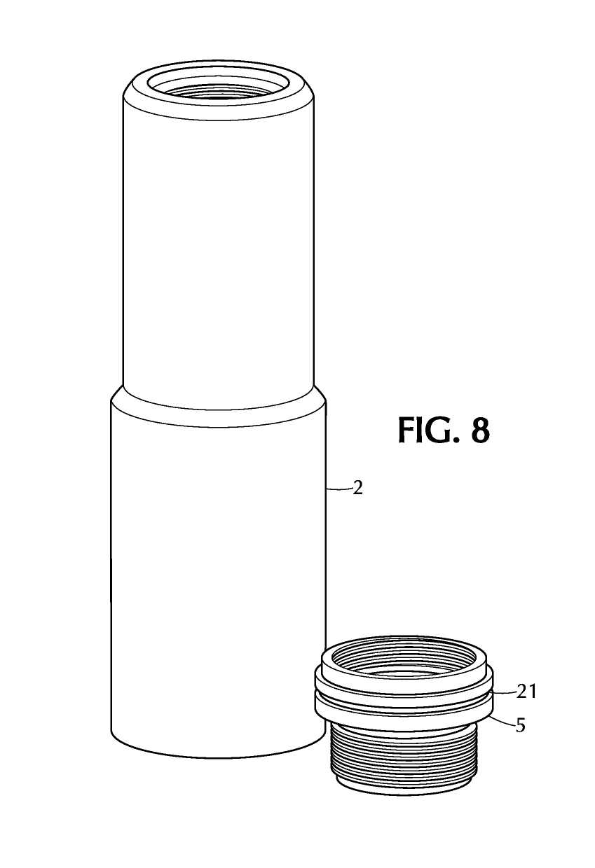

Referring to FIGS. 1-7, a preferred embodiment of the present invention is directed toward an improved safety valve 1 for performing oilfield operations. In a preferred embodiment FIG. 1 shows a safety valve 1 with an upper valve body 2, lower valve body 3, an internal ball valve 8, and an intermediate connector 5. An axial bore 11 is disposed internal to the valve body and which extends through valve body to allow fluids to pass through a valve. Upper valve body section 10 is preferably internally threaded and so can be operatively connected to an above-ground pumping system. Lower valve body section 4 is also preferably threaded and which can engage down-hole operations. An upper portion of the lower valve 3 is preferably threaded 6 to receive an oppositely threaded lower portion of upper valve body 2.

In a preferred embodiment, an intermediate connector 5 has an axial bore which axially aligns with the bores of the upper and lower valve bodies 2 3 and/or any seals or seats with similarly aligned bores. When axially compressed, the axial bores of the upper and lower valve bodies and intermediate connector 2 3 5 axially align to allow fluids to pass through. Preferably, this occurs when intermediate connector 5 is axially compressed through a male threaded connection 12 and wherein lower valve body 3 has an oppositely threaded connection to pair with intermediate connector 5. The terms “upper” and “lower” are used for convenience and for understanding relative positions however, those skilled in the art will appreciate that a reversal of the positions can yield the same result.

Further, those in the art will appreciate that complete exterior alignment of the exterior portion of upper and lower valve bodies is not required nor do they need to be perfectly flush on the exterior to achieve the desired result. For example, a first and second valve body can achieve the desired result if they pair through a tapered edge whereby the two valve bodies meet at the apex of one or both of their respective edges.

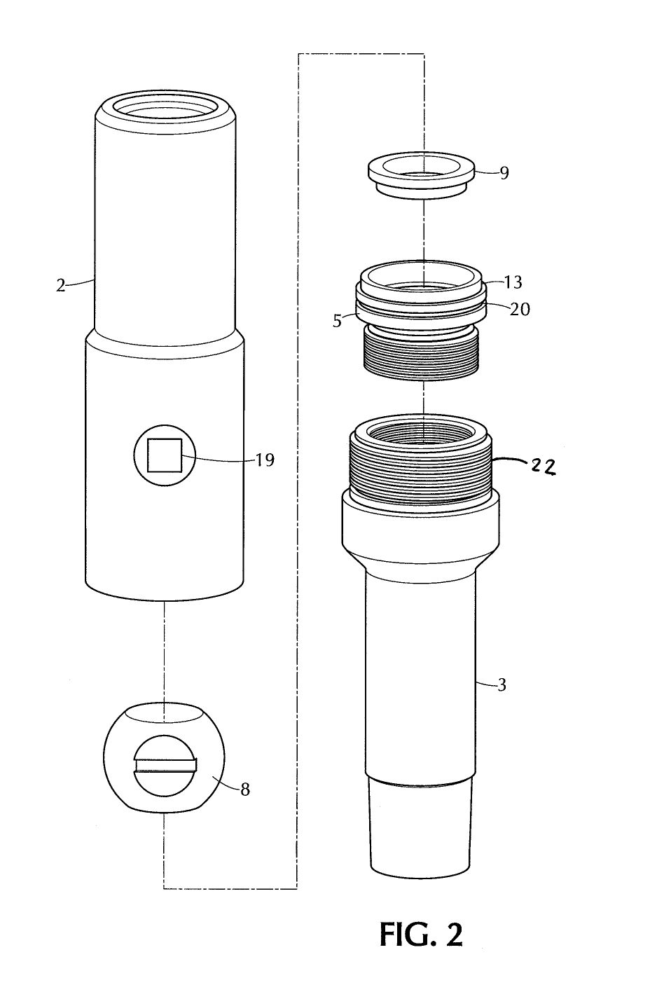

Referring to FIGS. 1 and 2, lower valve body 3 is preferably mated to upper valve body 2 through a threaded male end 22 (See, FIG. 2) on an upper portion of lower valve body which preferably receives an internally disposed female threaded end of upper valve body 3 to form a mated connection 6. When upper and lower valves bodies are threaded onto each other, ball valve 8 is caged between intermediate connector 5 and upper valve body 2. Intermediate connector 5 is further preferably disposed with an annular shoulder 13 on its upper portion. (See, FIG. 2 and FIGS. 6 and 7, Ref. No. 18) and which abuts an internal shoulder 14 disposed within the upper valve body. (FIG. 1) Upper valve body 2 is preferably internally adapted with an upper chamfer or shoulder 15 to prevent a valve, such as an internal ball valve from being displaced by well pressure when fully seated into the valve. Internal shoulder 15 can be comprised of an internal annular chamfer, a single or plurality of shoulder portions, or other known methods of shouldering an internal valve.

In a preferred embodiment, an annular shouldered valve seat and/or washer 9 is adapted to sit between a valve body and intermediate connector through fitted placement, threading, or other means for removably securing to intermediate connector 5. Annular seat 9 is preferably comprised of any material hard enough to withstand internal well pressures such as tungsten carbide, nickel, or stainless steel or other hardened metals. Annular seat 9 provides a durable smooth surface to allow a valve, such as a ball valve to turn and which can further prevent wear on an upper surface and upper edges of intermediate connector 5.

In another preferred embodiment, an upper annular shouldered valve seat and/or washer can be adapted to fit between valve and upper valve body through fitted placement into an upper internal valve shoulder or chamfer 15 or through threading or other means for removably securing to a valve.

In a preferred embodiment threading on the upper and lower valve bodies and intermediate connector can be reversed so as to achieve the same results as previously disclosed in the above embodiments.

In a preferred embodiment, the upper and lower valve bodies are generally tubular in nature however; those skilled in the art will appreciate that other shapes can be adapted to various well shapes and deformations. In a preferred embodiment, external circumferences of valve bodies can be flushly aligned along the entire length of the mated valve bodies or, in various other embodiments, may be partially axially aligned to accommodate well services.

In a preferred embodiment, intermediate connector 17 (See, FIGS. 6 and 7) can, in place of threading to secure to the lower valve body, be adapted to friction fit internal to a valve body and wherein axial compression and/or pressure exerted by the compression of the two valve bodies secures it in place. In this way, axial compression is not limited to threading but to axial pressure necessary to secure intermediate connector to a valve body. In a preferred embodiment, internal shoulder pairing or conjoining of a valve body and an intermediate connector prevents well pressure from displacing intermediate connector 17.

In a further preferred embodiment utilizing a friction-fitted arrangement as just described 17 or on a threaded connector 5, an annular groove 20 21 is disposed circumferentially around intermediate connector 5 17 and adapted to fit an o-ring or other flexible seal or washer to further prevent slippage and to create a greater seal of an intermediate connector on a valve body. In a further embodiment, an annular circumferential groove is disposed on a lower portion of a friction-fitted intermediate connector in addition to or separately from an annular groove on an upper portion.

The foregoing embodiments are merely examples of the present invention. Those skilled in the art may make numerous uses of, and departures from, such embodiments without departing from the scope of the present invention. Accordingly, the scope of the present invention is not limited to or defined by such embodiments in any way, but rather, is defined solely by the following claims.

I claim:

1. An improved safety valve for oilfield operations comprising:
a generally tubular first valve body comprising: an axial bore adapted to allow fluids to pass, a first end with means for operatively engaging pump equipment, and a second end adapted to axially compress with a second valve body;
the second valve body being generally tubular, comprising an axial bore, adapted to axially compress with a second end of an intermediate valve body connector and the second end of the first valve body, and a second end with means for operatively engaging pump equipment;
the intermediate valve body connector having an axial bore and means for axial compression with the second valve body;
the axial bores of the first and second valve bodies and the intermediate connector adapted to being axially aligned when compressed; and
a valve internally disposed between the first valve body and the intermediate valve body connector and the second valve body and actuated by an externally accessible torque means.

2. The improved safety valve for oilfield operations of claim 1 wherein the intermediate valve body connector further comprises an internal annular shoulder adapted to receive an annular valve seat.

3. The improved safety valve for oilfield operations of claim 1 wherein the valve is a ball valve.

5. The improved safety valve for oilfield operations of claim 1 wherein the intermediate connector is adapted to axially compress through a friction fit with the second valve body.

6. The improved safety valve for oilfield operations of claim 1 wherein the intermediate connector is adapted to threadably connect with the second valve body.

7. The improved safety valve for oilfield operations of claim 1 wherein the intermediate connector is disposed with an annular groove adapted to receive an annular seal.
